(19) United States
(12) Patent Application Publication
(10) Pub. No.: US 2008/0277332 A1
(43) Pub. Date: Nov. 13, 2008

(54) Micromachined membrane filter device for a glaucoma implant and method for making the same

(75) Inventor: Zhixiong (Eric) Liu, Bedford, MA (US)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Becton, Dickinson and Company

(21) Appl. No.: 11/798,238

(22) Filed: May 11, 2007

(51) Int. Cl. B01D 39/14

(52) U.S. Cl. 210/500.22; 216/37

(57) ABSTRACT

A MEMS-fabricated filter device for an ophthalmic shunt and a method for making the same. The filter device may include: a membrane with a plurality of pores, substantially uniformly sized to achieve a therapeutic flow rate while substantially preventing bacterial passage therethrough; a pair of substrates, each bonded to an opposing side of the membrane, and each having an axial inlet opening at a distal end thereof, and a cross-shaped support disposed in one of the substrates, the cross-shaped support supporting the membrane. The filter device may also include: a substrate having a passage therethrough; a membrane, axially recessed from opposing ends of the substrate and having a plurality of pores, substantially uniformly sized to achieve a therapeutic flow rate while substantially preventing bacterial passage therethrough; and a conformal coating covering the membrane. The method may include depositing a membrane layer on a substrate, patterning pores in the membrane layer to define an initial size of the pores, backside etching the substrate to the membrane layer, and conformally coating the membrane layer.

### BACKGROUND OF THE INVENTION

1. Field of the Invention

The present invention relates to a filter device for a medical device and manufacturing methods thereof. More particularly, certain implementations of the invention provide for a MEMS-fabricated filter device and/or flow restricting device (and manufacturing methods thereof) for an ophthalmic shunt for implantation through the cornea or sclera of an eye to relieve intraocular pressure in the anterior chamber, and for implantation through the sclera to introduce medications into the posterior chamber. As such, the embodiments of the present invention are useful, for example, in both transcorneal and transscleral applications.

2. Description of the Related Art

Glaucoma, a condition caused by optic nerve cell degeneration, is the second leading cause of preventable blindness in the world today. A major symptom of glaucoma is a high intraocular pressure, or “IOP,” which is caused by the trabecular meshwork failing to drain enough aqueous humor fluid from within the eye. Conventional glaucoma therapy has been directed at protecting the optic nerve and preserving visual function by attempting to lower IOP using various methods, such as using drugs or surgery methods, including trabeculectomy and the use of implants.

Trabeculectomy is a very invasive surgical procedure in which no device or implant is used. Typically, a surgical procedure is performed to puncture or reshape the trabecular meshwork by surgically creating a channel, thereby opening the sinus venosus. Another surgical technique typically used involves the use of implants, such as stems or shunts, positioned within the eye and which are typically relatively large. Such devices are implanted during any number of surgically invasive procedures, and serve to relieve internal eye pressure by permitting aqueous humor fluid to flow from the anterior chamber, through the sclera, and into a conjunctive bleb over the sclera. These procedures are very labor intensive for the surgeons and may be subject to failure due to scarring and cyst formations.

Another problem often related to the treatment of glaucoma with drugs relates to the challenge of delivering drugs to the eye. Current methods of delivering drugs to the eye are not as efficient or effective as desirable. Most drugs for the eye are applied in the form of eye drops, which have to penetrate through the cornea and into the eye. Drops are an inefficient way of delivering drugs; much of the drug never reaches the inside of the eye. Another treatment procedure includes injections. Drugs may be injected into the eye, but this is often traumatic and the eye typically needs to be injected on a regular basis.

One solution to the problems encountered with treatment of glaucoma using drops and injections involves the use of a transcorneal shunt, as disclosed herein. The transcorneal shunt is designed to be an effective means to reduce the intraocular pressure in the eye by shunting aqueous humor fluid from the anterior chamber of the eye. Surgical implantation is less invasive and quicker than other surgical options because the device is intended for implantation in the clear cornea. It drains aqueous humor fluid through the cornea to the tear film, rather than to the trabecular meshwork.

Some existing shunts, however, are subject to challenges in actual use. One challenge associated with shunt use is the regulation of aqueous outflow. Specifically, the drainage rate of the fluid from the eye is based upon drainage through the shunt as well as through tissue surrounding the newly implanted shunt—until there has been sufficient wound healing to restrict fluid outflow biologically. Providing restricted flow through the shunt while the wound was healing (and fluid was flowing through the wound) may then limit flow through the shunt too much after the wound had healed.

Another challenge associated with existing shunt use is the possibility of intraocular infection. In certain instances, an implant may provide a conduit through which bacteria can gain entry to the anterior chamber, thereby resulting in intraocular infections. Certain drainage devices have introduced filter devices, valves, or other conduit systems that serve to impede the transmission of infection into the anterior chamber but these mechanisms have their limitations. Even when effective in resisting the transmission of microorganisms, these mechanisms have hydraulic effects on fluid outflow that may impair effective drainage.

Additional details of ophthalmic shunts can be found, for example, in U.S. patent application Ser. No. 10/857,452, entitled “Ocular Implant and Methods for Making and Using Same,” filed Jun. 1, 2004 and published Jun. 2, 2005 under U.S. Publication No. 2005/0119737 A1, as well as International Patent Application No. PCT/US01/00350, entitled “Systems And Methods For Reducing Intraocular Pressure”, filed on Jan. 5, 2001 and published on Jul. 19, 2001 under the International Publication No. WO 01/50943. Details of ophthalmic shunts can also be found in U.S. Pat. No. 5,807,302, entitled “Treatment of Glaucoma,” filed Apr. 1, 1996 and issued Sep. 15, 1998. The entire contents of these applications and this patent are incorporated herein by reference.

### SUMMARY OF THE INVENTION

Accordingly, it is an aspect of embodiments of the present invention to provide a robust filter device for a transcorneal shunt for use in providing controlled anterior chamber drainage while limiting ingress of microorganisms. It is another aspect of embodiments of the present invention to provide an efficient method of manufacturing such a filter device.

The foregoing and/or other aspects of embodiments of the present invention are achieved by providing a MEMS-fabricated filter device for an ophthalmic shunt. The filter device may include: a substrate having a passage therethrough; a membrane, said membrane being axially recessed from opposing ends of the substrate and having a plurality of pores, substantially uniformly sized to achieve a therapeutic flow rate while substantially preventing bacterial passage therethrough; and a conformal coating covering the membrane.

The foregoing and/or other aspects of embodiments of the present invention are also achieved by providing a MEMS-fabricated filter device for an ophthalmic shunt. The filter device may include: a membrane with a plurality of pores, sized to achieve a therapeutic flow rate while substantially preventing bacterial passage therethrough; a pair of substrates disposed on opposing sides of the membrane, each having a cross-shaped support supporting the membrane and an axial inlet opening at a distal end thereof; and a conformal coating covering the membrane and the substrates.

The foregoing and/or other aspects of embodiments of the present invention are also achieved by providing a MEMS-fabricated filter device for an ophthalmic shunt. The filter device may include: a substrate of unitary construction with a passage therethrough; and a membrane, said membrane having an outer circumferential portion disposed at a first end of the substrate and a central portion axially recessed from opposing ends of the substrate, and having a plurality of pores, substantially uniformly sized to achieve a therapeutic flow rate while substantially preventing bacterial passage therethrough.

The foregoing and/or other aspects of embodiments of the present invention are also achieved by providing a method of manufacturing a MEMS-fabricated filter device for an ophthalmic shunt. The method may include: etching a recess on a first end of a substrate to support a membrane; conformally depositing a core membrane on the first end of the substrate, covering the recess; etching an initial size of pores in the membrane; etching a central portion of the substrate from a second end, opposite the first end, until the membrane is reached; and conformally coating the membrane and substrate, whereby a size of the pores is finalized and the membrane is strengthened.

The foregoing and/or other aspects of embodiments of the present invention are also achieved by providing a MEMS-fabricated filter device for an ophthalmic shunt. The filter device may include: a first substrate with a passage therethrough; and a membrane having a plurality of pores, substantially uniformly sized to achieve a therapeutic flow rate while substantially preventing bacterial passage therethrough, the membrane being disposed at a first end of the first substrate. The filter device also includes a second substrate having a recess to accommodate the membrane. The second substrate has a plurality of axial passages acting as a pre-filter to the membrane. The second substrate is also bonded at an outer peripheral portion thereof to an outer peripheral portion of the first substrate such that the axial passages of the second substrate substantially align with the passage of the first substrate.

The foregoing and/or other aspects of embodiments of the present invention are also achieved by providing a method of manufacturing a MEMS-fabricated filter device for an ophthalmic shunt. The method may include depositing a membrane layer on a first substrate, removing a portion of the membrane layer by patterning to define a bonding area on the first substrate, and patterning pores in the membrane layer to define an initial size of the pores. The method also includes backside etching the substrate to the membrane layer, conformally coating the membrane layer and the first substrate to finalize the pore size, and etching a cavity in a second substrate to accommodate the membrane. Further, the method includes etching inlet ports in the second substrate to function as a pre-filter for the membrane, and fusion boding the second substrate on the bonding area of the first substrate.

The foregoing and/or other aspects of embodiments of the present invention are also achieved by providing a MEMS-fabricated filter device for an ophthalmic shunt. The filter device may include: a membrane with a plurality of pores, substantially uniformly sized to achieve a therapeutic flow rate while substantially preventing bacterial passage therethrough; a pair of substrates, each bonded to an opposing side of the membrane, and each having an axial inlet opening at a distal end thereof, and a cross-shaped support disposed in one of the substrates, the cross-shaped support supporting the membrane.

The foregoing and/or other aspects of embodiments of the present invention are also achieved by providing a method of manufacturing a MEMS-fabricated filter device for an ophthalmic shunt. The method may include depositing a membrane layer on a substrate, patterning pores in the membrane layer to define an initial size of the pores, backside etching the substrate to the membrane layer, and conformally coating the membrane layer.

The foregoing and/or other aspects of embodiments of the present invention are also achieved by providing a method of manufacturing a MEMS-fabricated filter device for an ophthalmic shunt. The method may include: defining pores in a silicon membrane layer of a silicon on insulator (SOI) wafer using a first photo mask, oxidizing a top and bottom of a silicon wafer to define a mask side and an etch stop side of the silicon wafer, and creating alignment marks on the silicon wafer using a second photo mask. The method may also include fusion bonding the etch stop side of the silicon wafer to the silicon membrane of the SOI wafer, annealing the wafers and oxidizing exposed ends of the wafers, and etching the oxide on the silicon wafer and deep reactive ion etching the silicon of the silicon wafer to the etch stop oxide of the silicon wafer using the second photo mask. Further, the method includes etching the oxide on the SOI wafer and deep reactive ion etching the silicon of the SOI wafer to the insulator of the SOI wafer using a third photo mask, removing the oxide on opposing sides of the silicon membrane layer using a timing etch, and cover coating the silicon membrane layer, SOI wafer, and the silicon wafer.

Additional and/or other aspects, objects, and advantages of the present invention will be set forth in part in the description that follows and, in part, will be apparent from the description, or may be learned by practice of the invention.

### BRIEF DESCRIPTION OF THE DRAWINGS

The above and/or other aspects and advantages of the invention will become apparent and more readily appreciated from the following detailed description, taken in conjunction with the accompanying drawings, in which:

FIG. 1 illustrates an example of a transcorneal shunt;

FIG. 2 illustrates an example of a substantially racetrack-shaped pore according to an embodiment of the present invention;

FIG. 3 illustrates an example of a membrane with substantially racetrack-shaped pores according to an embodiment of the present invention;

FIGS. 4A and 4B illustrate MEMS-fabricated filter devices for an ophthalmic shunt according to embodiments of the present invention;

FIGS. 5A-5E illustrate a method of manufacturing a MEMS-fabricated filter device for an ophthalmic shunt according to an embodiment of the present invention;

FIG. 6 illustrates a MEMS-fabricated filter device according to an embodiment of the present invention;

FIGS. 7A-7H illustrate a method of manufacturing a MEMS-fabricated filter device for an ophthalmic shunt according to an embodiment of the present invention;

FIG. 8A illustrates a MEMS-fabricated filter device according to an embodiment of the present invention;

FIG. 8B illustrates a cross section of a membrane of FIG. 8A;

FIGS. 8C and 8D illustrate MEMS-fabricated filter devices for an ophthalmic shunt according to embodiments of the present invention;

FIG. 9 illustrates a MEMS-fabricated filter device according to an embodiment of the present invention;

FIG. 10 illustrates an example of a transcorneal shunt according to an embodiment of the present invention;

FIG. 11 illustrates dimensional ratios of a racetrack-shaped pore for determining a shape factor thereof;

FIGS. 12A-12K illustrate a method of manufacturing a MEMS-fabricated filter device for an ophthalmic shunt according to an embodiment of the present invention; and

FIG. 13 illustrates micro-channels connecting pores in a membrane according to an embodiment of the present invention.

### DETAILED DESCRIPTION

Reference will now be made in detail to embodiments of the present invention, examples of which are illustrated in the accompanying drawings, wherein like reference numerals refer to the like elements throughout.

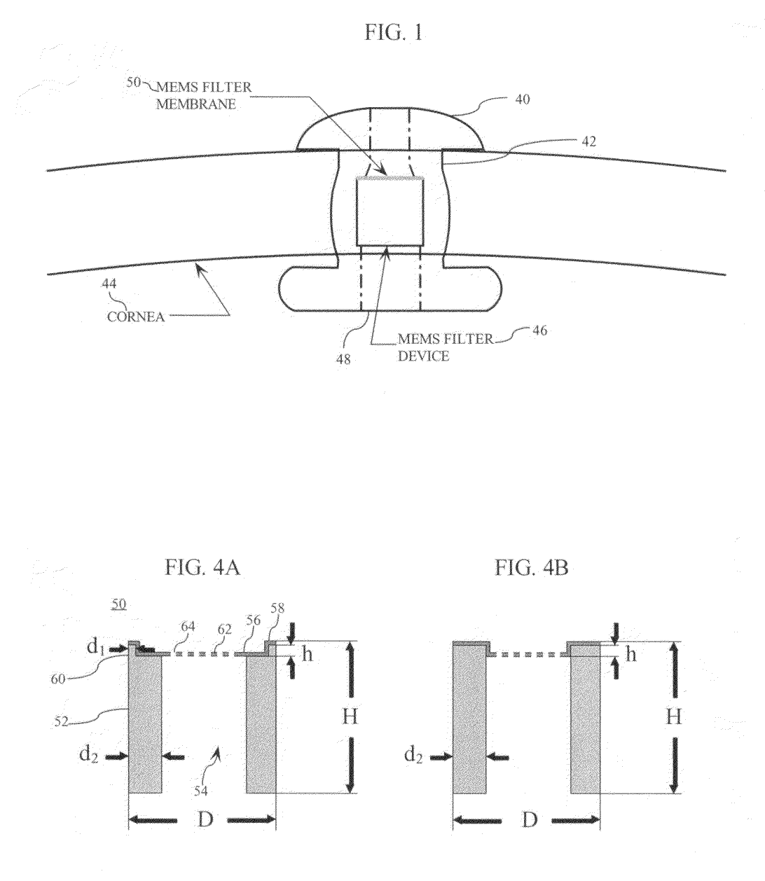

FIG. 1 illustrates an example of a transcorneal shunt. FIG. 1 shows the shunt 40 inserted through an incision 42 in cornea 44. A Micro-Electro-Mechanical Systems (MEMS) filter device 46, disposed in a central passage 48 of the shunt 40, has a perforated membrane 50 to regulate aqueous humor outflow and limit ingress of microorganisms.

In some MEMS membrane filter devices, the thin membrane is fabricated to sit on top of a silicon support and is thereby exposed directly to potential damage during handling or assembly. Thus, the mechanical strength of such a membrane is a concern, since it lacks protection for handling or assembly.

Certain MEMS membrane filter devices may provide a limited flow rate, rendering them ineffective in connection with a glaucoma implant. Further, for features smaller than about 1 micron, photolithography may not be sufficiently effective to define pore size accurately and with appropriate precision because the resolution of photolithography is limited.

Accordingly, a need exists for a more robust filter device for a transcorneal shunt or implant for use in providing controlled anterior chamber drainage while limiting ingress of microorganisms. Still further, a need exists for a more efficient method of manufacturing such a filter device.

A filter device used for a glaucoma shunt or implant, for example, a transcorneal shunt, is a device that preferably provides an outflow path for aqueous humor from the anterior chamber to the tear film and regulates the outflow at a desired flow rate while preventing bacteria from passing into the eye through the passageway. Such a device should preferably meet and balance several criteria: the overall size of the shunt should be relatively small to reduce trauma to the patient; the filter device should be sufficiently fine to be able to retain bacteria as small as 0.5 micron or less, yet the filter device should also be able to provide a sufficient flow rate of aqueous humor out from the chamber of the eye.

The driving force for the aqueous humor flow is intraocular pressure. Through experimentation, a flow rate of 3 microliter/min at 10 mmHg intraocular pressure at 37° C. is set as the design goal to achieve therapeutic relief. In other words, this design goal is a therapeutic flow rate. To prevent bacterial passage and control the flow of aqueous humor to provide the desired therapeutic relief of the intraocular pressure, one reliable approach to producing submicron pores in a MEMS filter device is to define initial openings via photolithography, and then deposit a conformal cover coating to narrow down the pores to the desired size. A conformal coating means that the thickness of the coating will grow isotropically, in other words, substantially identically in all directions. Such an approach enables a very tight pore size, and thus, a precisely designed flow rate.

If, for example, circular pores of 1 micron in diameter are initially defined in a core membrane by photolithography, and then a 0.25 micron thick cover coating is deposited from both sides of the core membrane, the final pore size will be 0.5 micron in diameter, as calculated as: 1−(2×0.25)=0.5. An even smaller pore size, i.e., 0.3 or 0.2 micron is achievable by varying the initial opening size and the thickness of cover coating.

For the circular pore example, based on the Hagen-Poiseuille law for the laminar flow through a capillary, the flow rate (Q) through each pore can be calculated as: Q=πr⁴Δp/(8ηL), where r is the pore radius, L is the pore length (which is the membrane thickness in this case), Δp is the pressure drop, and η is the fluid viscosity. Viscosity of aqueous humor is close to that of water, which is 0.6915×10⁻³ Pascal*sec at 37° C. If the total membrane thickness which is the sum of the core membrane and the cover coating thickness is 1 micron and the final pore diameter is 0.5 micron, the flow rate through one pore at 10 mmHg pressure (1.33×10³ Pascals) can be calculated as: Q=3.14×0.25⁴×1.33×10³/(8×0.6915×10⁻³×1)=2.95×10³ μm³/s=2.95×10⁻⁶ μl/s.

If an overall diameter of a filter device D is 0.5 mm and a wall thickness of a silicon frame, d₂ is 0.1 mm (see, e.g., FIGS. 4A and 4B), the total number of pores available for flow is about 17500, assuming the initial pore size is 1 micron in diameter and the initial spacing from center to center of pores is 2 microns. Thus, the total flow rate through the membrane is: 2.95×10⁻⁶×17500=0.0516 μl/s=3.1 μl/min. Thus, such a design achieves a therapeutic flow rate.

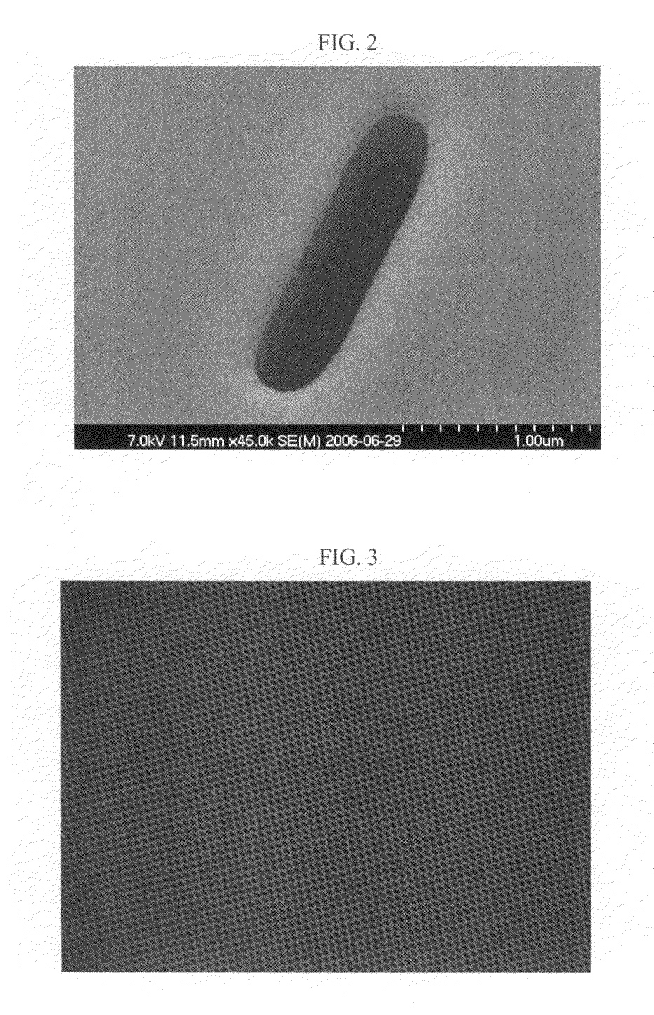

Embodiments of the present invention are not limited to circular pores. Embodiments of the present invention can include, for example, pores that are substantially oval-shaped, substantially rectangular, substantially hexagonal, or substantially racetrack-shaped, or some combination thereof, including circular pores. FIG. 2 illustrates an example of a substantially racetrack-shaped pore, and FIG. 3 illustrates an example of a membrane with substantially racetrack-shaped pores. Flow rate through a substantially racetrack-shaped pore will be discussed in more detail later.

Particularly desirable options for the cover coating include, for example, low-pressure chemical vapor deposition (LPCVD) of silicon nitride, plasma enhanced chemical vapor deposition (PECVD) of silicon dioxide, deposition of Parylene, sputtering of titanium, or deposition of silver-containing antimicrobial coating. LPCVD is a technique in which one or more gaseous reactors are used to form a solid insulating or conducting layer on the surface of a wafer under low pressure and high temperature conditions. PECVD is a technique in which one or more gaseous reactors are used to form a solid insulating or conducting layer on the surface of a wafer, and this formation can be enhanced by the use of a vapor containing electrically charged particles or plasma, at lower temperatures.

An appropriate cover coating provides chemical protection to the bulk material of a filter device. Over time, bodily fluid may attack silicon, causing it to degrade. A chemically inert covering will protect the bulk material of a silicon filter device. Further, such a cover coating can be employed to modify the surface chemistry of a filter device, providing a high degree of hydrophilicity to aid the initiation of flow (discussed in more detail later).

To provide a more robust filter device, one approach is to etch a recess in a silicon support before membrane deposition, to recess the membrane within the silicon support.

FIGS. 4A and 4B illustrate two examples of such an approach. FIG. 4A illustrates, for example, a MEMS-fabricated filter device 50 for an ophthalmic shunt. The filter device 50 has a substrate 52 of unitary construction with a passage 54 therethrough. The filter device 50 also has a membrane 56 that has an outer circumferential portion 58 disposed at a first end 60 of the substrate 52 and a central portion 62 axially recessed from opposing ends of the substrate 52. The membrane 56 has a plurality of pores 64 that are substantially uniformly sized to achieve a therapeutic flow rate while substantially preventing bacterial passage therethrough.

In more detail, FIG. 4A illustrates a cross section of a substantially cylindrical filter device 50 with a diameter D. A recess positioned in the first end 60 of the cylindrical substrate 52 yields a wall thickness d₁ at the first end 60. The remainder of the cylindrical substrate 52 has a wall thickness d₂. The recess has made depth h from the distal end of the cylindrical substrate 52, and the entire filter device 50 has an axial height H.

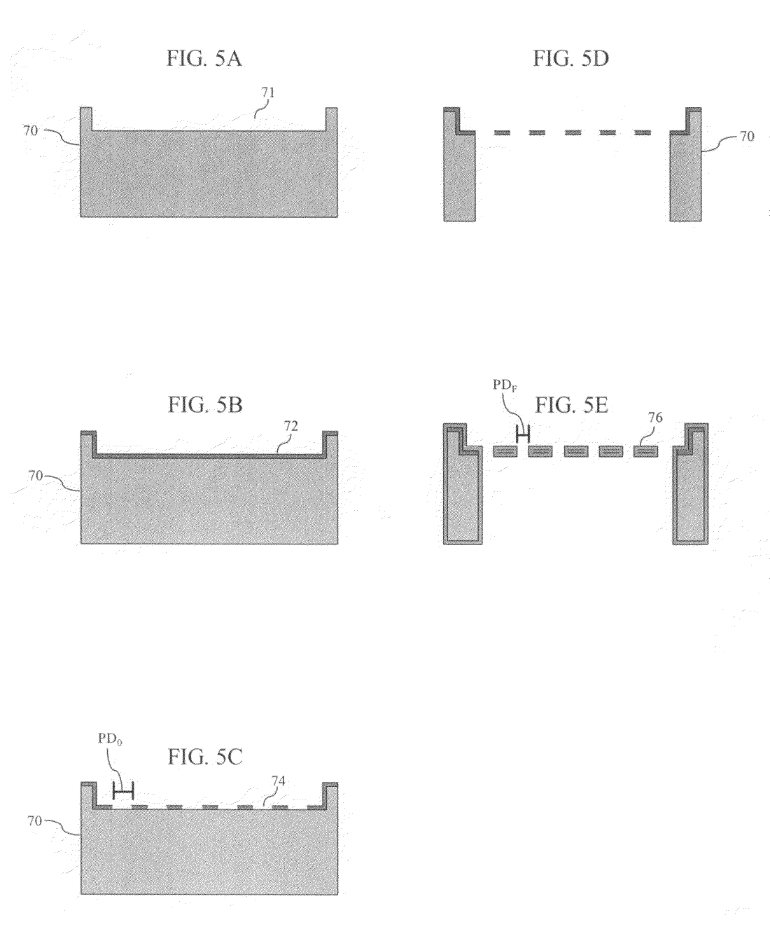

FIGS. 5A-5E illustrate a method of manufacturing a MEMS-fabricated filter device for an ophthalmic shunt according to an embodiment of the present invention. FIGS. 5A-5E illustrate, for example, depositing a membrane layer 72 on a substrate 70 (see FIG. 5B), patterning pores 74 in the membrane layer 72 to define an initial size PD₀ of the pores (see FIG. 5C), backside etching the substrate 70 to the membrane layer 72 (see FIG. 5D), and conformally coating 76 the membrane layer 72 (see FIG. 5E).

In more detail, FIGS. 5A-5E illustrate a detailed fabrication process flow of manufacturing a filter device for an ophthalmic shunt, for example, the filter device of FIG. 4A. The first operation, as illustrated in FIG. 5A, is etching a recess 71 in a silicon substrate 70 to support a membrane, using reactive ion etching (RIE). FIG. 5B illustrates the second operation, which is conformally depositing a cover coating 72 to cover a first end of substrate 70, including recess 71, to form a core membrane 72. According to one embodiment, the conformal cover coating 72 may be, e.g., a silicon nitride layer.

The third operation, shown in FIG. 5C is etching pores 74 (for example using photolithography) to define an initial pore diameter PD₀ in the membrane 72. The next operation then, shown in FIG. 5D, is etching an opening in a central portion of the silicon substrate 70 from the backside (second end, opposite to the first end) until reaching the membrane layer 72, using deep reactive ion etching (DRIE). For brevity, the operation shown, for example, in FIG. 5D, may also be referred to as “backside etching.”

RIE uses chemically reactive plasma to remove material deposited on silicon wafers. The plasma is generated under low pressure (e.g., a vacuum) by an electromagnetic field. High-energy ions from the plasma attack the wafer surface and react with the wafer surface. DRIE is a highly anisotropic (i.e. directionally dependent) etch process used to create deep, steep-sided holes and trenches in silicon wafers.

FIG. 5E illustrates the last operation, which comprises conformally depositing a cover coating 76. This final operation narrows down the pores to the desired final diameter PD_{F} and also enhances the membrane 72 strength. According to one embodiment, the cover coating 76 is achieved by applying more than one coating. In other words, the cover coating 76 may be built up to define the pore size to the desired final diameter PD_{F}. Thus, as a final product, FIG. 5E illustrates a MEMS-fabricated filter device for an ophthalmic shunt having the following: a substrate 70 with a passage therethrough; a membrane 72 that is axially recessed from opposing ends of the substrate 70 and has a plurality of pores 74, that are substantially uniformly sized to achieve a therapeutic flow rate while substantially preventing bacterial passage therethrough; and a conformal coating 76 covering the membrane 72.

According to one embodiment, e.g., FIG. 5E, conformal cover coating 76 covers not only membrane 72, but also substrate 70. Further, according to one embodiment, the conformal cover coating 76 may be, e.g., silicon dioxide. Further still, according to another embodiment, the conformal cover coating 76 may be, e.g., titanium. Yet further still, according to yet another embodiment, the conformal cover coating 76 may be, e.g., a silver-containing antimicrobial coating. Even yet further still, according to still yet another embodiment, the conformal cover coating 76 may be, e.g., silicon nitride.

Looking back at FIG. 4B, this embodiment is similar to that of FIG. 4A. The embodiment of FIG. 4B can be manufactured using a process similar to that illustrated in FIGS. 5A-5E. One primary difference between the embodiments of FIGS. 4A and 4B is that in FIG. 4B, the entire cylindrical substrate has a wall thickness d₂. To accomplish this, the diameter of the recess etched in the first manufacturing operation (e.g. FIG. 5A) is merely not as large as that defined for the embodiment shown in FIG. 4A. In other words, to manufacture the embodiment shown in FIG. 4B, the recess etched in the first manufacturing operation has a diameter R_{d} defined as R_{d}=D−(2d₂), where D is the diameter of the cylindrical filter device and d₂ is wall thickness of the cylindrical substrate. Otherwise, the manufacturing process illustrated in FIGS. 5A-5E can be followed to produce the embodiment of FIG. 4B.

Another approach to solving the difficulties describes with respect to conventional MEMS membrane filter devices is to fabricate a filter device with an encapsulated membrane. FIG. 6 illustrates a filter device according to an embodiment of the present invention. As shown in FIG. 6, there is a MEMS-fabricated filter device 78 for an ophthalmic shunt, having a first substrate 80 with a passage 82 therethrough, and a membrane 84 having a plurality of pores 86, substantially uniformly sized to achieve a therapeutic flow rate while substantially preventing bacterial passage therethrough. The membrane 84 is disposed at a first end 88 of the first substrate 80. The filter device also has a second substrate 90 with a recess 92 to accommodate the membrane 84. The second substrate 90 has a plurality of axial passages 94 that collectively act as a pre-filter to the membrane 84. Second substrate 90 has an outer peripheral portion corresponding to an outer peripheral portion of the first substrate 80, at which the two substrates 80 and 90 bond such that the axial passages 94 of the second substrate 90 substantially align with the passage 82 of the first substrate 80.

FIGS. 7A-7H illustrate a method of manufacturing a filter device for an ophthalmic shunt according to an embodiment of the present invention. The method illustrated in FIGS. 7A-7H may be used, for example, to manufacture the filter device illustrated in FIG. 6. In the detailed process flow illustrated in FIGS. 7A-7H, the first operation, FIG. 7A, is depositing a membrane layer 100 on a first substrate 102. According to one embodiment, the first operation is LPCVD of silicon nitride layer as a core membrane.

If a thickness of the silicon nitride membrane is too great, difficulties may arise in later operations when two substrates are fused using silicon fusion bonding, since a silicon nitride layer that is too thick may prevent such bonding. Accordingly, FIG. 7B shows the next operation, which comprises removing a portion of the membrane layer 100 by patterning to define a bonding area on the first substrate 102. In this operation, a periphery of the silicon nitride membrane is removed as a bonding site for a later operation.

FIG. 7C illustrates a third operation, which comprises patterning pores 104 in the membrane layer 100 to define an initial size of the pores 104 (i.e., an initial pore diameter PD₀). According to one embodiment, photolithography is employed to pattern the silicon nitride to define the initial pore size.

Next, FIG. 7D illustrates backside etching the substrate 102 to the membrane layer 100. In other words, a central portion of the silicon substrate is etched from the backside using DRIE until reaching the silicon nitride membrane.

A fifth operation is shown in FIG. 7E. This operation comprises conformally coating 106 the membrane layer 100 and the first substrate 102 to finalize the pore size. The deposited coating 106 finalizes not only the final diameter of the pores (PD_{F}), but the total thickness of membrane 100 as well.

A cavity accommodating the membrane and inlet pores are respectively etched in a cap wafer in two steps. FIG. 7F illustrates etching a cavity 108 in a second substrate 110 to accommodate the membrane 100, and FIG. 7G illustrates etching inlet ports 112 in the second substrate 110 to function as a pre-filter for the membrane 100.

Finally, FIG. 7H illustrates fusion boding the second substrate on the bonding area of the first substrate. Thus the bonding area of the first substrate 102, patterned in the operation shown in FIG. 7B, is employed to bond the cap wafer (second substrate 110) to the structural wafer (first substrate 102) using silicon fusion bonding.

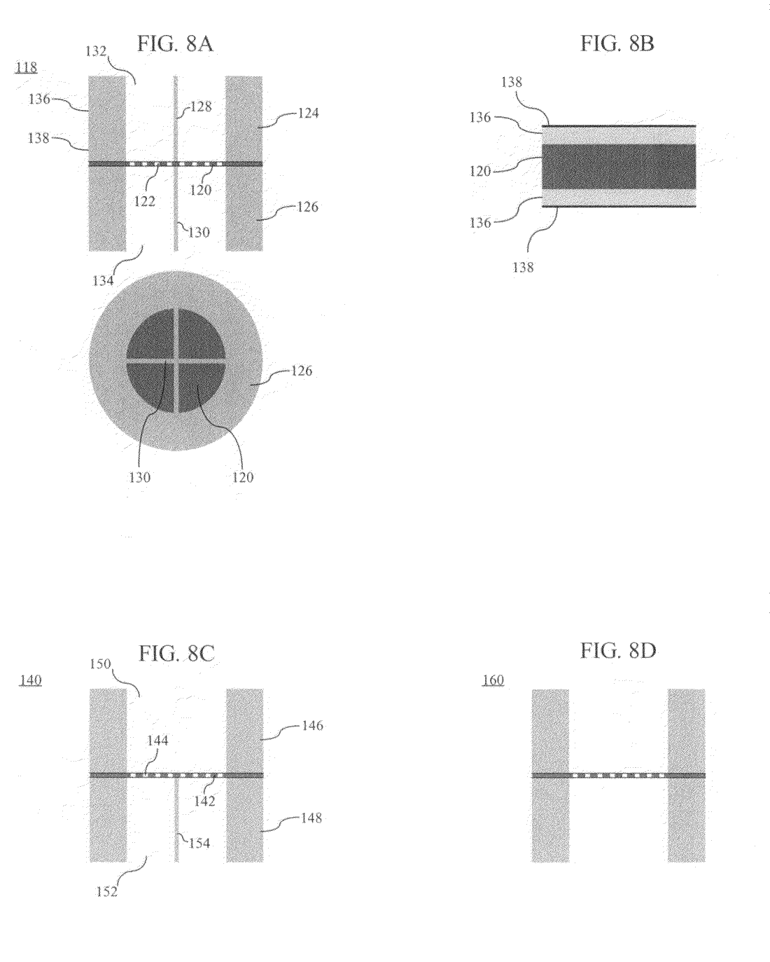

Similar to the filter device shown in FIG. 6, FIG. 8A illustrates a filter device according to an embodiment of the present invention with an encapsulated membrane. FIG. 8A illustrates a cross-sectional side view and a plan view of a MEMS-fabricated filter device 118 for an ophthalmic shunt, having the following: a membrane 120 with a plurality of pores 122, sized to achieve a therapeutic flow rate while substantially preventing bacterial passage therethrough; a pair of substrates 124 and 126 disposed on opposing sides of the membrane 120, each having a cross-shaped support 128 and 130 supporting the membrane 120 and an axial inlet opening 132 and 134 at a distal end thereof; and a conformal coating 136 covering the membrane and the substrates.

According to one embodiment, cross-shaped supports 128 and 130 are integrally formed as unitary constructions with substrates 124 and 126, respectively.

According to one embodiment, the filter device 118 also has a second coating 138 disposed on the coating 136. According to one embodiment, the second coating 138 is silicon dioxide, titanium, gold, platinum, titanium nitride, or a silver containing antimicrobial coating. FIG. 8B illustrates a cross section of membrane 120 with conformal coating 136 and second coating 138. Such a composite membrane provides greater strength than an uncoated membrane. According to one embodiment, membrane 120 is single crystal silicon (SCS), conformal coating 136 is silicon nitride, and second coating 138 is titanium.

In tests, titanium coatings have been shown to be both highly bio-stable and highly biocompatible. But in greater thicknesses, titanium coatings may not be highly conformal. It has been learned that, if the titanium coatings are very thin, the conformality problems are effectively relieved. In contrast, silicon nitride coatings are highly conformal, but may not be as highly bio-stable and highly biocompatible as titanium coatings. According to one embodiment, the filter device 118 has membrane 120 that is SCS, and conformal coating 136 of silicon nitride that is approximately 0.2-0.25 microns thick, and a second coating 138 of titanium that is approximately 0.02-0.05 microns (20-50 nanometers) thick, and thus, is effectively conformal. And since coatings 136 and 138 cover both the membrane 120 and substrates 124 and 126, the titanium coating 138 provides a high degree of bio-stability and biocompatibility for filter device 118. Additionally, research has shown that biomimetic coatings, e.g., Phosphorylcholine (PC) or Polyethylene glycol (PEG) may increase the longevity of glaucoma shunts. Such biomimetic coatings potentially prevent protein adsorption and cell attachment. According to one embodiment, the second coating 138 is a biomimetic coating.

Similar to the filter device shown in FIG. 8A, FIG. 8C illustrates a cross-sectional side view a MEMS-fabricated filter device 140 for an ophthalmic shunt, having the following: a membrane 142 with a plurality of pores 144, substantially uniformly sized to achieve a therapeutic flow rate while substantially preventing bacterial passage therethrough; a pair of substrates 146 and 148, each bonded to an opposing side of the membrane 142, and each having an axial inlet opening 150 and 152 at a distal end thereof; and a cross-shaped support 154 disposed in one of the substrates 148, the cross-shaped support 154 supporting the membrane 142.

According to one embodiment, cross-shaped support 154 is integrally formed as a unitary construction with substrate 148.

Similar to the filter devices shown in FIGS. 8A and 8C, FIG. 8D illustrates a filter device 160 according to an embodiment of the present invention with an encapsulated membrane. Unlike filter devices 118 and 140, however, filter device 160 does not have cross-shaped supports.

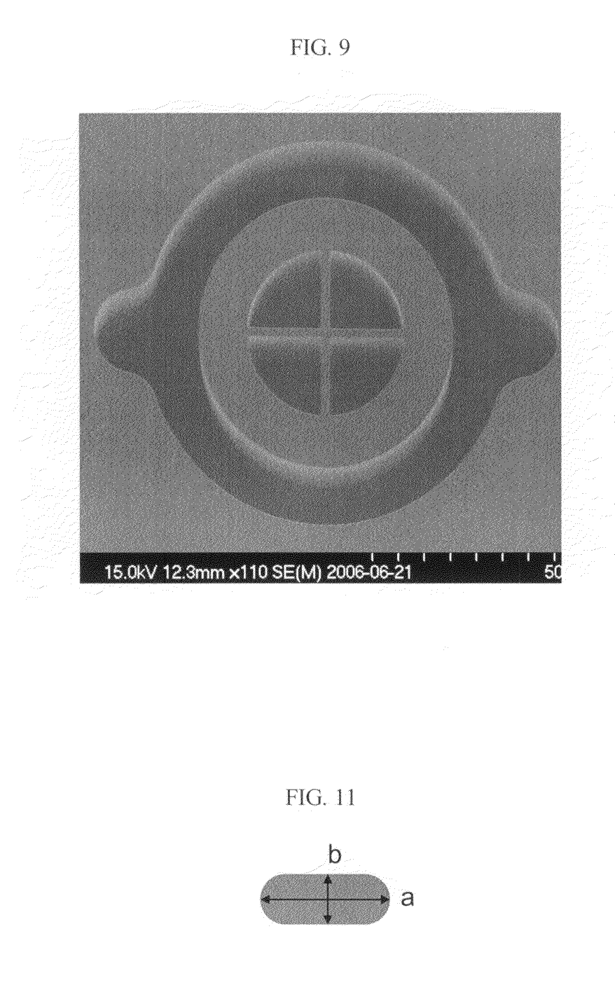

FIG. 9 shows a plan view of an embodiment of the present invention with a cross-shaped support.

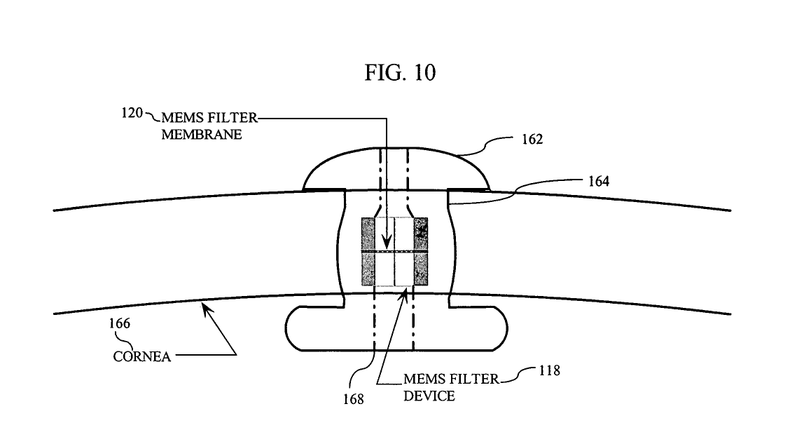

FIG. 10 illustrates an example of a transcorneal shunt according to an embodiment of the present invention. FIG. 10 shows the shunt 162 inserted through an incision 164 in cornea 166. A Micro-Electro-Mechanical Systems (MEMS) filter device, e.g., the filter device 118 shown in FIG. 8A, disposed in a central passage 168 of the shunt 162, has a perforated membrane 120 to regulate aqueous humor outflow and limit ingress of microorganisms.

As noted previously, the pores, e.g., pores 122 in membrane 120 of the filter device 118 in FIG. 8A, may be substantially racetrack-shaped. A benefit of such racetrack-shaped pores is that the narrow dimension of the pores can be made small enough to prevent bacterial passage, while the long dimension of the pores can be made large enough to provide a sufficient flow rate. To determine the flow rate of a racetrack-shaped pore, the formula is somewhat more complex than for a circular pore:

$$Q = \frac{{[ \frac{4 ( a - b ) b + π {b}^{2}}{π b + 2 ( a - b )} ]}^{2} [ ( a - b ) b + \frac{π {b}^{2}}{4} ]}{k η L} Δ p ,$$

where Q is the volumetric flow rate, Δp is the pressure drop, k is a shape factor (a constant determined by the ratio of a and b—see FIG. 11), η is the viscosity, and L is the pore length (membrane thickness).

Looking at the filter device of FIG. 8A, for example, if the final membrane thickness is 1 μm, at 37° C. the flow rate through one 1.5×0.3 μm pore is 3.49×10⁻⁴ μl/min at 10 mmHg pressure. When the overall diameter of the device is 500 μm, the wall thickness is 100 μm, the width of the cross support is 20 μm, the respective spacings between the pore area to the cross-shaped support and to the wall are both 5 μm, the total number of pores available for flow is about 9600 when the initial spacing between the pores is 0.9 μm. Thus, the total flow rate through the membrane is 3.49×10−4×9600=3.35 μl/min.

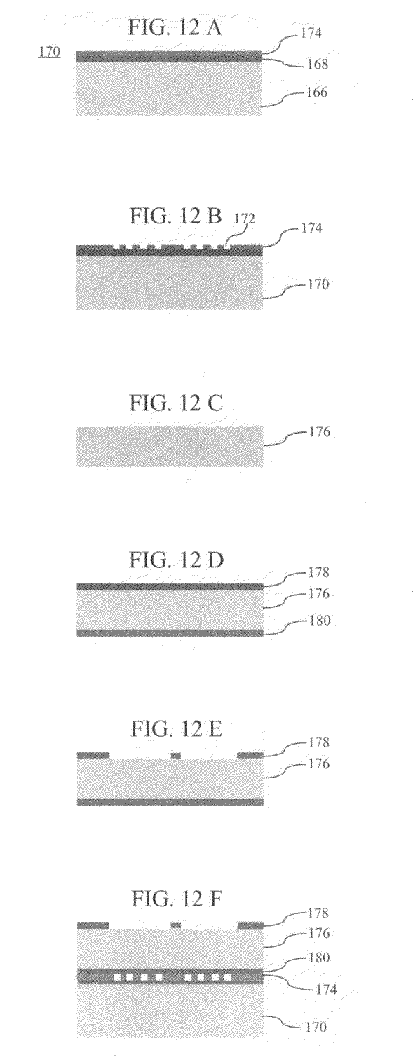

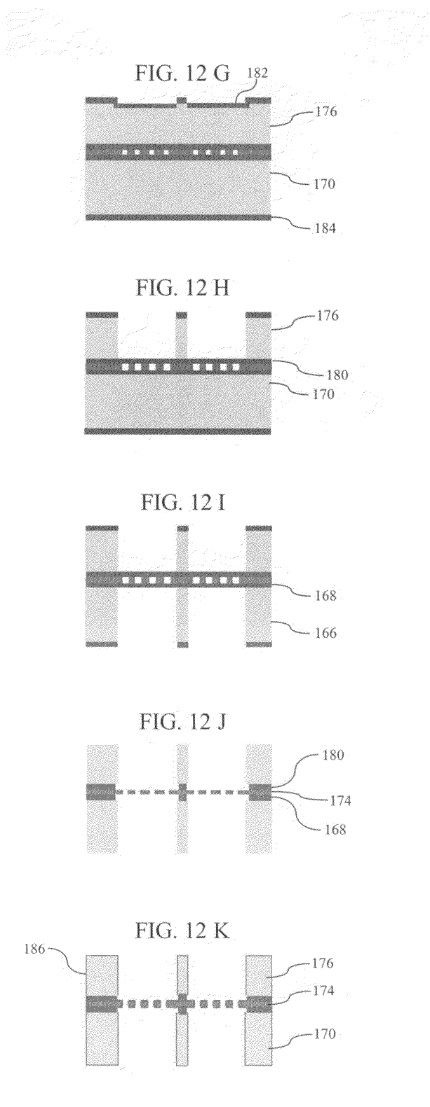

FIGS. 12A-12K illustrate a method of manufacturing a MEMS-fabricated filter device for an ophthalmic shunt according to an embodiment of the present invention. The method illustrated in FIGS. 12A-12K may be used, for example, to manufacture the filter device shown in FIG. 8A. Since single crystal silicon (SCS) can be used as the core membrane, the fabrication process can be started with a Silicon on Insulator (SOI) wafer 170, as shown in FIG. 12A. The SOI wafer 170 has silicon 166, an insulator layer 168 on the silicon 166, and an SCS membrane 174 on the insulator 168.

FIG. 12B illustrates defining pores 172 in a silicon membrane layer 174 of the (SOI) wafer 170 using a first photo mask. Next, FIG. 12C illustrates starting another wafer, e.g., a silicon wafer. Though top and bottom axial orientation of this finished filter device is independent, the silicon wafer may also be referred to as a “top” wafer.

In the following operation, FIG. 12D illustrates oxidizing a top 178 and bottom 180 of the silicon wafer 176 to define a mask side 178 and an etch stop side 180 of the silicon wafer 176. The next operation is illustrated in FIG. 12E: creating alignment marks on the silicon wafer 176 using a second photo mask. Both the oxide 178 and the silicon 176 are etched to define these alignment marks that will be used in subsequent fusion bonding.

FIG. 12F illustrates fusion bonding the etch stop side 180 of the silicon wafer 176 to the silicon membrane 174 of the SOI wafer 170. It is important to note that the silicon wafer 176 and the SOI wafer 170 should be properly aligned prior to the bonding.

The next operation, as shown in FIG. 12G, is annealing the wafers 170 and 176 and oxidizing 182 and 184 exposed ends of the wafers 170 and 176. According to one embodiment, the annealing of the wafers occurs between approximately 850-2000° C. The oxidation in this operation is similar to that shown in FIG. 12D.

After the annealing operation, FIG. 12H illustrates etching the oxide 182 on the silicon wafer 176 and deep reactive ion etching (DRIE) the silicon of the silicon wafer 176 to the etch stop oxidation 180 of the silicon wafer 176. In other words, the etching proceeds until reaching the bottom oxide 180 applied in the operation depicted in FIG. 12D. Additionally, the current operation employs the same photo mask in the operation shown in FIG. 12E. Next, in a similar operation, FIG. 12I illustrates etching the oxide 184 on the SOI wafer and deep reactive ion etching (DRIE) the silicon 166 of the SOI wafer 170 to the insulator 168 of the SOI wafer 170, using a third photo mask.

FIG. 12J illustrates removing the oxide 168 and 180 on opposing sides of the silicon membrane layer 174 using a timing etch. As can be seen in FIG. 12J, the timing etch may begin to etch away portions of the oxide 168 and 180 contiguous with the silicon making up the substrates and cross-shaped supports. Thus, as a design consideration, a radial thickness (in other words, a width—right to left, as shown in FIG. 12J) of the oxide ultimately disposed between the substrates and the silicon membrane layer 174 (in other words, between the cross supports and the silicon membrane layer 174 and also buried in the substrate walls) should be thicker than the amount of oxide intended to be removed during the timing etch. Put another way, a lateral dimension of the oxide, as shown in FIG. 12J, should be much greater than a vertical dimension, so that during the timing etch, the lateral erosion will not have a significant impact on the structural integrity of the device.

Lastly, FIG. 12K illustrates cover coating 186 the silicon membrane layer 174, SOI wafer 170, and the silicon wafer 176. According to one embodiment, the cover coating 186 is a single coating, e.g., silicon nitride, silicon dioxide, or titanium. According to one embodiment, the cover coating 186 is a double coating, e.g., silicon nitride plus silicon dioxide, silicon nitride plus titanium, silicon nitride plus silver-containing antimicrobial coating, silicon nitride plus gold, silicon nitride plus platinum, silicon nitride plus titanium nitride, silicon nitride plus Phosphorylcholine (PC), or silicon nitride plus Polyethylene glycol (PEG).

Thus far, embodiments have been described with reference to employing a silicon substrate. But embodiments of the present invention are not limited to silicon substrates. For example, according to one embodiment, quartz, glass, or other similar ceramics may be used as a substrate.

In producing submicron pores in a MEMS filter device, as pore size is reduced in the membranes to prevent bacterial passage through the device, the initiation of flow may become increasingly difficult under expected intraocular pressure, which presumably is less than 100 mm Hg. As previously mentioned, surface treatments, such as thin layer coatings, modify the surface chemistry of the filter devices, to aid flow inducement.

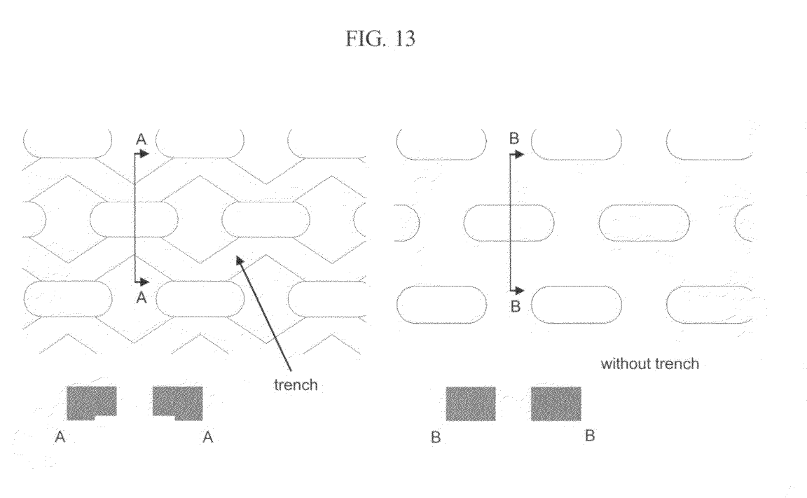

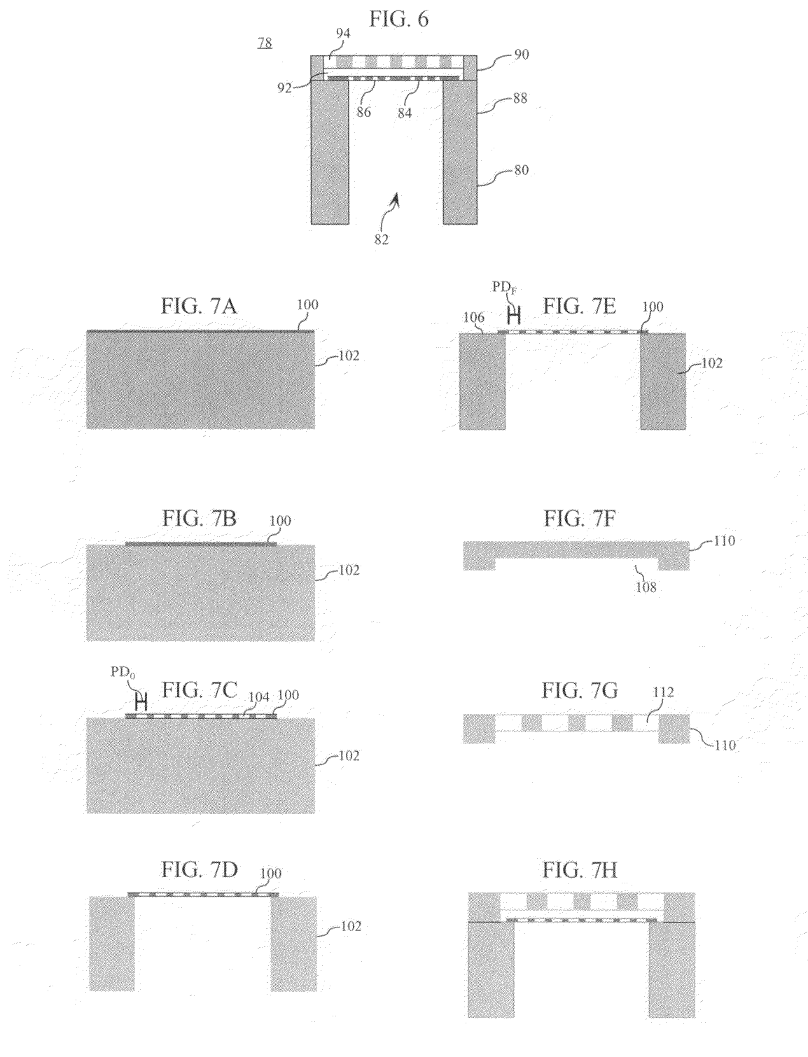

Another approach to improve self-wetting, as illustrated in FIG. 13, is to construct connecting micro-channels or trenches between pores. Such trenches help break tiny droplets that potentially form at the entrance or exit of the pores due to surface tension. Without the trenches, these droplets can create a backpressure that resists flow initiation. The fluid in the droplets formed from different pores travels through the connecting trenches, joins together and breaks down the backpressure, thereby facilitating the initiation of flow. According to one embodiment, the depth of the trenches is approximately 0.1-0.2 μm.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A MEMS-fabricated filter device for an ophthalmic shunt, comprising:
a substrate having a passage therethrough;
a membrane, said membrane being axially recessed from opposing ends of the substrate and having a plurality of pores, substantially uniformly sized to achieve a therapeutic flow rate while substantially preventing bacterial passage therethrough; and
a conformal coating covering the membrane.

2. The filter device according to claim 1, wherein the substrate comprises silicon.

3. The filter device according to claim 1, wherein the substrate comprises one of quartz and glass.

4. The filter device according to claim 1, wherein the conformal coating is deposited.

5. The filter device according to claim 1, wherein the filter device is substantially cylindrical.

6. The filter device according to claim 1, wherein the membrane has a plurality of surface micro-channels connecting adjacent pores.

7. The filter device according to claim 1, wherein the pores are one of substantially oval-shaped, substantially circular, substantially rectangular, and substantially hexagonal.

8. The filter device according to claim 1, wherein the pores are substantially racetrack-shaped.

9. The filter device according to claim 1, wherein the substrate has a recess disposed at a first end thereof, in which the membrane is disposed.

10. The filter device according to claim 9, wherein the conformal coating covers the substrate.

11. The filter device according to claim 1, wherein:
the substrate comprises a first substrate portion bonded with a second substrate portion;
the membrane is disposed therebetween;
the conformal coating covers the first substrate portion; and
the first and second substrates have respective axial inlet openings at distal ends thereof.

12. The filter device according to claim 11, wherein the second substrate has a cavity defined therein to accommodate the membrane, and a plurality of axial inlet openings at the distal end thereof.

13. The filter device according to claim 11, wherein the conformal coating covers the second substrate portion.

14. The filter device according to claim 13, wherein the first substrate portion comprises a cross-shaped support disposed therein supporting the membrane.

15. The filter device according to claim 14, wherein the second substrate portion comprises a cross-shaped support disposed therein supporting the membrane.

16. The filter device according to claim 13, further comprising a second coating deposited on the conformal coating.

17. The filter device according to claim 16, wherein the second coating comprises one of silicon dioxide, titanium, gold, platinum, titanium nitride, Phosphorylcholine (PC), Polyethylene glycol (PEG), and a silver containing antimicrobial coating.

18. The filter device according to claim 16, wherein the second coating comprises titanium.

19. The filter device according to claim 1, wherein the membrane comprises one of single crystal silicon and silicon nitride; and
the conformal coating comprises one of silicon nitride, silicon dioxide, Parylene, a silver film, an antimicrobial material, and titanium.

20. The filter device according to claim 1, wherein:
the membrane comprises single crystal silicon; and
the conformal coating comprises silicon nitride.

21. A MEMS-fabricated filter device for an ophthalmic shunt, comprising:
a membrane having a plurality of pores, sized to achieve a therapeutic flow rate while substantially preventing bacterial passage therethrough;
a pair of substrates disposed on opposing sides of the membrane, each having a cross-shaped support supporting the membrane and an axial inlet opening at a distal end thereof; and
a conformal coating covering the membrane and the substrates.

22. The filter device according to claim 21, wherein the substrates comprise silicon.

23. The filter device according to claim 21, wherein the substrates comprise at least one of quartz and glass.

24. The filter device according to claim 21, wherein the conformal coating is deposited.

25. The filter device according to claim 21, further comprising a second coating disposed on the conformal coating.

26. The filter device according to claim 25, wherein the second coating is deposited on the conformal coating.

27. The filter device according to claim 25, wherein:
the membrane comprises a single crystal silicon;
the conformal coating comprises silicon nitride; and
the second coating comprises titanium.

28. The filter device according to claim 21, wherein the filter device is substantially cylindrical.

29. The filter device according to claim 21, wherein the membrane has a plurality of surface micro-channels connecting adjacent pores.

30. The filter device according to claim 21, wherein the pores are substantially racetrack-shaped.

31. A MEMS-fabricated filter device for an ophthalmic shunt, comprising:
a substrate of unitary construction having a passage therethrough; and
a membrane, said membrane having an outer circumferential portion disposed at a first end of the substrate and a central portion axially recessed from opposing ends of the substrate, and having a plurality of pores, substantially uniformly sized to achieve a therapeutic flow rate while substantially preventing bacterial passage therethrough.

32. The filter device according to claim 31, further comprising a conformal coating covering the filter device.

33. The filter device according to claim 31, wherein the membrane has a plurality of surface micro-channels connecting adjacent pores.

34. The filter device according to claim 31, wherein the pores are substantially racetrack-shaped.

35. A method of manufacturing a MEMS-fabricated filter device for an ophthalmic shunt, comprising:
etching a recess on a first end of a substrate to support a membrane;
conformally depositing a core membrane on the first end of the substrate, covering the recess;
etching an initial size of pores in the membrane;
etching a central portion of the substrate from a second end, opposite the first end, until the membrane is reached; and
conformally coating the membrane and substrate, whereby a size of the pores is finalized and the membrane is strengthened.

36. A MEMS-fabricated filter device for an ophthalmic shunt, comprising:
a first substrate having a passage therethrough;
a membrane having a plurality of pores, substantially uniformly sized to achieve a therapeutic flow rate while substantially preventing bacterial passage therethrough, the membrane being disposed at a first end of the first substrate; and
a second substrate having a recess to accommodate the membrane, the second substrate having a plurality of axial passages acting as a pre-filter to the membrane, the second substrate being bonded at an outer peripheral portion thereof to an outer peripheral portion of the first substrate such that the axial passages of the second substrate substantially align with the passage of the first substrate.

37. The filter device according to claim 36, further comprising a conformal coating covering the membrane and the first substrate.

38. The filter device according to claim 36, wherein the membrane has a plurality of surface micro-channels connecting adjacent pores.

39. The filter device according to claim 36, wherein the pores are substantially racetrack-shaped.

40. A method of manufacturing a MEMS-fabricated filter device for an ophthalmic shunt, comprising:
depositing a membrane layer on a first substrate;
removing a portion of the membrane layer by patterning to define a bonding area on the first substrate;
patterning pores in the membrane layer to define an initial size of the pores;
backside etching the substrate to the membrane layer;
conformally coating the membrane layer and the first substrate to finalize the pore size;
etching a cavity in a second substrate to accommodate the membrane;
etching inlet ports in the second substrate to function as a pre-filter for the membrane; and
fusion boding the second substrate on the bonding area of the first substrate.

41. A MEMS-fabricated filter device for an ophthalmic shunt, comprising:
a membrane having a plurality of pores, substantially uniformly sized to achieve a therapeutic flow rate while substantially preventing bacterial passage therethrough;
a pair of substrates, each bonded to an opposing side of the membrane, and each having an axial inlet opening at a distal end thereof; and
a cross-shaped support disposed in one of the substrates, the cross-shaped support supporting the membrane.

42. The filter device according to claim 41, wherein the cross-shaped support is integrally formed as a unitary construction with the substrate.

43. The filter device according to claim 41, further comprising a second cross-shaped support disposed in the remaining one of the substrates, each of the cross-shaped supports supporting the membrane.

44. The filter device according to claim 43, wherein the cross-shaped supports are integrally formed as respective unitary constructions with the substrates.

45. The filter device according to claim 41, further comprising a conformal coating covering the membrane and the substrates.

46. The filter device according to claim 41, wherein the membrane has a plurality of surface micro-channels connecting adjacent pores.

47. The filter device according to claim 41, wherein the pores are substantially racetrack-shaped.

48. A method of manufacturing a MEMS-fabricated filter device for an ophthalmic shunt, comprising:
depositing a membrane layer on a substrate;
patterning pores in the membrane layer to define an initial size of the pores;
backside etching the substrate to the membrane layer; and
conformally coating the membrane layer.

49. The method according to claim 48, wherein the conformally coating the membrane layer comprises at least one coating, where each coating shrinks a size of the pores.

50. A method of manufacturing a MEMS-fabricated filter device for an ophthalmic shunt, comprising:
defining pores in a silicon membrane layer of a silicon on insulator (SOI) wafer using a first photo mask;
oxidizing a top and bottom of a silicon wafer to define a mask side and an etch stop side of the silicon wafer;
creating alignment marks on the silicon wafer using a second photo mask;
fusion bonding the etch stop side of the silicon wafer to the silicon membrane of the SOI wafer;
annealing the wafers and oxidizing exposed ends of the wafers;
etching the oxide on the silicon wafer and deep reactive ion etching the silicon of the silicon wafer to the etch stop oxide of the silicon wafer using the second photo mask;
etching the oxide on the SOI wafer and deep reactive ion etching the silicon of the SOI wafer to the insulator of the SOI wafer using a third photo mask;
removing the oxide on opposing sides of the silicon membrane layer using a timing etch; and
cover coating the silicon membrane layer, SOI wafer, and the silicon wafer.

51. The method according to claim 50, wherein the cover coating the silicon membrane layer, SOI wafer, and the silicon wafer comprises depositing a conformal coating on the silicon membrane layer, SOI wafer, and the silicon wafer.

52. The method according to claim 51, wherein the cover coating the silicon membrane layer, SOI wafer, and the silicon wafer further comprises depositing a second coating on the conformal coating.

53. The method according to claim 52, wherein:
the conformal coating comprises silicon nitride; and
the second coating comprises titanium.

54. The method according to claim 50, wherein the etching the oxide on the silicon wafer and deep reactive ion etching the silicon of the silicon wafer to the etch stop oxidation of the silicon wafer comprises forming a cross-shaped support in the silicon wafer to support the silicon membrane layer.

55. The method according to claim 50, wherein the etching the oxide on the SOI wafer and deep reactive ion etching the silicon of the SOI wafer to the insulator of the SOI wafer comprises forming a cross-shaped support in the SOI wafer to support the silicon membrane layer.

56. The method according to claim 50, wherein:
the etching the oxide on the silicon wafer and deep reactive ion etching the silicon of the silicon wafer to the etch stop oxidation of the silicon wafer comprises forming a cross-shaped support in the silicon wafer to support the silicon membrane layer; and
the etching the oxide on the SOI wafer and deep reactive ion etching the silicon of the SOI wafer to the insulator of the SOI wafer comprises forming a cross-shaped support in the SOI wafer to support the silicon membrane layer.
